(19) United States
(12) Patent Application Publication
(10) Pub. No.: US 2018/0240336 A1
(43) Pub. Date: Aug. 23, 2018

(54) MULTI-STREAM BASED TRAFFIC ENFORCEMENT FOR COMPLEX SCENARIOS

(71) Applicant: Safer Place Ltd., Tel Aviv (IL)

(72) Inventors: Uri KAREEV, Tel Aviv (IL); Ari SCHRIEBER, Ramat Gan (IL); Ori BERGER, New York, NY (US)

(73) Assignee: Safer Place Ltd., Tel Aviv (IL)

(21) Appl. No.: 15/874,150

(22) Filed: Jan. 18, 2018

Related U.S. Application Data
(63) Continuation of application No. PCT/US2016/042990, filed on Jul. 19, 2016.
(60) Provisional application No. 62/194,233, filed on Jul. 19, 2015.

(51) Int. Cl. G08G 1/04; G08G 1/017; G08G 1/01; G06K 9/00; G06K 9/32

(52) U.S. Cl. CPC G08G 1/04; G08G 1/0175; G08G 1/0133; G06Q 50/26; G06K 9/325; G08G 1/0116; G06K 2209/15; G06K 9/00771

(57) ABSTRACT

A method and system for monitoring and enforcing suspect traffic violations using multiple data streams are provided. The method comprises capturing a video stream of traffic in a field of view of a first traffic monitoring system; identifying a license plate number of a vehicle shown in the captured view stream; obtaining data streams from at least one second traffic monitoring system; identifying a driving pattern of the vehicle based on the captured video stream and the obtained data streams; and analyzing the identified driving pattern and the license plate number of the vehicle to determine a suspect traffic violation committed by the vehicle.

### CROSS-REFERENCE TO RELATED APPLICATIONS

This application is a continuation of International Application No. PCT/US2016/042990 filed on Jul. 19, 2016 which claims the benefit of U.S. Provisional Patent Application No. 62/194,233 filed on Jul. 19, 2015, the contents of which are hereby incorporated by reference.

### TECHNICAL FIELD

The present disclosure relates generally to traffic, moving and/or parking monitoring systems, and more specifically to a system for detecting and monitoring of the occurrence of traffic violations and providing respective video and still photographic evidence of the violations.

### BACKGROUND

Camera-based traffic monitoring systems are deployed by law enforcement agencies and municipalities to enforce traffic laws (including parking laws) in an attempt to detect unsafe driving behavior and illegal parking.

Existing solutions for camera-based traffic monitoring are based on video and/or stills footage used for prosecution of drivers in violation of traffic laws. Studies show that most existing solutions successfully identify a low percentage of all traffic violations due to the complexity involved in identifying certain violations. For example, existing solutions face particular challenges in identifying violations related to improperly using a public transportation lane; general reckless driving; and/or parking violations, such as blocking a bus stop, parking in a place that obstructs view of a junction, and otherwise not complying with parking regulations.

One of the reasons for the deficiencies of existing solutions is that such solutions perform only static analyses of traffic violations. In a typical analysis utilized by existing solutions, the cameras generate a single or a few frames of the vehicle being present in the alleged state of the violation. The low number of frames may not be sufficient to determine if the vehicle is in violation.

Specifically, for some violations such as improper use of public transportation lanes within city, the presence of a vehicle in a specific lane may be legal or illegal. For example, a car with one or more passengers or a taxi may not be in violation when driving in a car pool lane, while other vehicles may be. Further, during certain hours, public transportation lanes may not be restricted for traffic. Therefore, in such cases, the determination of whether the vehicle has committed a traffic violation is subject to a specific set of rules and current conditions required for identification of such violations.

Therefore, in view of the deficiencies noted above, a solution that would identify a higher percentage of traffic violations, and that would be flexibly deployable and efficient to operate, would be advantageous.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for monitoring and enforcing suspect traffic violations using multiple data streams. The method comprises capturing a video stream of traffic in a field of view of a first traffic monitoring system; identifying a license plate number of a vehicle shown in the captured view stream; obtaining data streams from at least one second traffic monitoring system; identifying a driving pattern of the vehicle based on the captured video stream and the obtained data streams; and analyzing the identified driving pattern and the license plate number of the vehicle to determine a suspect traffic violation committed by the vehicle.

Certain embodiments disclosed herein also include a system for monitoring and enforcing suspect traffic violations comprising. The system comprises at least one camera; a processing circuity; and a memory, the memory containing instructions that, when executed by the processing circuity, configure the system to: capture, using the at least one camera, a video stream of traffic in a field of view of a first traffic monitoring system; identify a license plate number of a vehicle shown in the captured view stream; obtain data streams from at least one second traffic monitoring system; identify a driving pattern of the vehicle based on the captured video stream and the obtained data streams; and analyze the identified driving pattern and the license plate number of the vehicle to determine a suspect traffic violation committed by the vehicle.

### BRIEF DESCRIPTION OF THE DRAWINGS

The subject matter disclosed is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a block diagram of a traffic monitoring system for traffic enforcement in complex scenarios according to an embodiment.

FIG. 2 is a diagram showing a deployment of a plurality of traffic monitoring systems according to an embodiment.

FIGS. 3A and 3B are diagrams of demonstration traffic violations using information provided by a plurality of multiple traffic monitoring systems.

FIG. 4 is a flowchart of a method for monitoring and enforcing traffic violations according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various example embodiments disclosed herein include a system and method for defining, monitoring, and reporting incidences of potential traffic violations. Traffic violations may include moving and non-moving (e.g., parking) violations. In an embodiment, the disclosed system utilizes at least video clips illustrating potential parking violations, and as necessary still images thereof. In an embodiment, the system is configured to enable evidence detection and collection for the purpose of off-line ticket generation respective of traffic violations. Other features of the disclosed system may include, but are not limited to, monitoring various types of traffic violations defined for a particular location or instance and which are usually considered complex to track. Other features of the disclosed system may further include real-time ticketing as well as dispatching a notification to a registered owner of a vehicle.

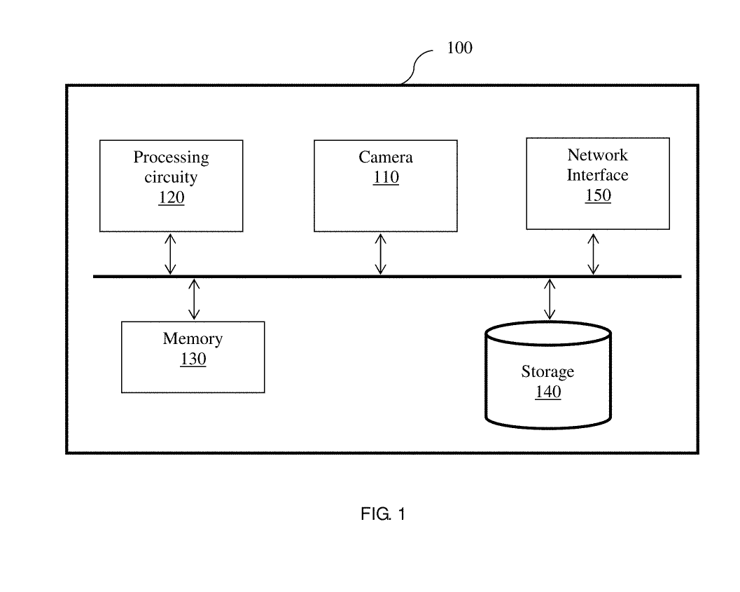

FIG. 1 shows an example block diagram of a traffic monitoring system 100 for traffic enforcement in complex scenarios according to an embodiment. The traffic monitoring system 100 includes at least one camera 110, a processing circuity 120 coupled to a memory 130, a storage 140, and a network interface 150. In an embodiment, the camera 110 is designed to capture high-resolutions stills and video enabled for legally acceptable enforcement standards. For example, the camera 110 may be a high-definition camera meeting particular specifications required by, e.g., law enforcement rules and regulations. In another embodiment, the camera 110 may be an infra-red camera, a 3D camera, a light field camera, a synthetic aperture camera, a depth sensing camera, or any other camera capable of capturing visual representations of vehicles and their surroundings.

The traffic monitoring system 100 is independently configured to be positioned in a certain area, to monitor the area, and to identify traffic violations in the monitored area. The traffic monitoring system 100 may be stationary (e.g., mounted, for example, on a pole). In another embodiment, the system traffic monitoring 100 may be portable (e.g., installed in a patrolling vehicle, or carried by a person such as a police officer or a traffic warden). In such an embodiment, the camera 110 can be assembled on at least one side of the patrolling vehicle.

In another embodiment, the traffic monitoring system 100 may be configured to capture or to record a video stream on a continuous basis or may otherwise be manually activated by a user through, for example, a user interface. In yet another embodiment, the traffic monitoring system may be equipped with a global positioning system (GPS), a license plate recognition (LPR) system (neither shown in FIG. 1), or both. Alternatively, the traffic monitoring system 100 may be configured to query such systems to obtain the requested information.

The motoring and enforcement of traffic violations is based on video streams captured by the camera 110, by cameras installed in other traffic monitoring systems (not shown in FIG. 1) that are communicatively connected to the traffic monitoring system 100, or by a combination thereof. In an embodiment, the traffic monitoring system 100 is configured to analyze the data streams and, in particular, video streams, to detect complex traffic violations, i.e., traffic violations that would not be apparent from simple analysis of a captured image (e.g., a red-light traffic violation).

Moving traffic violations that can be monitored and enforced using the disclosed system include, but are not limited to, blocking a junction, lane cutting, lane-to-lane crossing while disturbing traffic, crossing over white lines, driving on the shoulder of the road, not keeping to the right of the road, dangerous overtaking, tailgating (i.e., driving too close to a vehicle in front of another vehicle), lane blocking, not yielding when so required, not giving the right of way, overtaking from the right when not allowed, running a red light, school bus overtaking (i.e., passing a school bus when its “Stop” sign is displayed and its lights are blinking), speeding by a predefined threshold speed over the speed limit, failing to maintain a safe distance from other vehicles, crossing a railroad crossing when an indication of a nearing train is active, failing to slow or stop at a pedestrian crossing, driving in a public transportation lane, illegal parking, and so on and so forth.

Non-moving traffic violations monitored and enforced by the system include parking violations such as, but not limited to, parking or stopping in a restricted area, (such as a no parking zone or a no stopping zone), parking on the curbside, parking on a pedestrian crosswalk, parking on the sidewalk, parking at a bus station, and so on and so forth.

In an embodiment, the traffic monitoring system 100 may be configured to operate on a particular set of violations. The traffic monitoring system 100 may be further configured with a set of triggering events that would lead to an indication of a potential moving or non-moving violation. It should be noted that, for each violation, there may be one or more video clips and possibly one or more still images associated thereto.

As an example for detecting a public lane traffic violation, the traffic monitoring system 100 is configured to capture a video stream of a vehicle driving in a road designated as a public transportation lane. The traffic monitoring system 100 is configured to analyze the video stream to at least identify the vehicle's license plate and the driving pattern of the vehicle in the lane. The vehicle's license plate may be recognized using image processing techniques. The traffic monitoring system 100 is also configured to query an external database or databases to determine if traffic in the lane is currently restricted to publication transportation and to query, using the license plate number, if the suspected vehicle is a public transportation vehicle (e.g., a bus, a taxi, an emergency vehicle, and so on).

Further, in the example, based on the analyzed information, the traffic monitoring system 100 is configured to determine whether the vehicle is allowed to be in the lane. Such determination may be in cases where the vehicle is determined to be a bus, an emergency vehicle, or other vehicle that is allowed to be in the lane as determined based on the license plate. In cases where the driving pattern of the vehicle indicates that the vehicle is turning, the vehicle may not be considered in violation. In case of alleged determined violation, a violation report is generated and sent to an enforcement system. The violation report may include the identified license plate, a video clip of the violation, a geographic location, a date, a time, and so on.

In an embodiment, when the captured video streams from the camera 110 do not include any clear evidence that the violation would occur, a request for additional streams from different systems (not shown) or cameras (not shown) can be requested. The plurality of streams captured from different sources can provide a complete coverage of a road, a junction, and the like. Such coverage enables determination of whether certain type of traffic violations have occurred. For example, when the vehicle does not merge in or out of the lane and, therefore, is determined to not have committed a violation. The embodiments for processing data streams from multiple sources are discussed in greater detail below.

According to various configurations, the processing circuity 120 may be realized by one or more hardware logic components and circuits. For example, and without limitation, illustrative types of hardware logic components that can be used include Field Programmable Gate Arrays (FPGAs), Application-specific Integrated Circuits (ASICs), general-purpose microprocessors, microcontrollers, digital signal processors (DSPs), graphical processing units (GPUs), and the like, or any other hardware logic components that can perform calculations or other manipulations of information. The memory 130 may be volatile (e.g., RAM, etc.), non-volatile (e.g., ROM, flash memory, etc.), or a combination thereof.

The storage 140 may be magnetic storage, optical storage, and the like, and may be realized, for example, as flash memory or other memory technology, CD-ROM, digital versatile disks (DVDs) or other optical storage, magnetic cassettes, magnetic tape, a network storage (NFS), magnetic disk storage or other magnetic storage devices, or any other medium which can be used to store the desired information. The storage 140 may be utilized to store video clips, violation repots, local traffic laws, data streams retrieved from systems, combinations thereof, and so on.

In one configuration, computer readable instructions to implement one or more embodiments disclosed herein may be stored in the storage 140. The storage 140 may also store other computer readable instructions to implement an operating system, an application program, and the like. Computer readable instructions may be loaded in the memory 130 for execution by the processing circuity 120. The storage 140 is configured to store, for example, received events, modeled events, data structures, and so on.

In another embodiment, the storage 140, the memory 130, or both are configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuity 120 to perform the various functions described herein.

The network interface 150 allows the traffic monitoring system 100 to communicate with other traffic monitoring systems, databases, or other servers (some of which are discussed below). The network interface 150 may include a modem, a network interface card (NIC), an integrated network interface, a radio frequency transmitter/receiver, an infrared port, a USB connection, and the like.

It should be noted that the embodiments described herein with respect to FIG. 1 are discussed with respect to one camera 110 merely for simplicity purposes and without limitation on the disclosed embodiments. Multiple cameras may each be included in or communicatively connected to the traffic monitoring system 100 without departing from the scope of the disclosure.

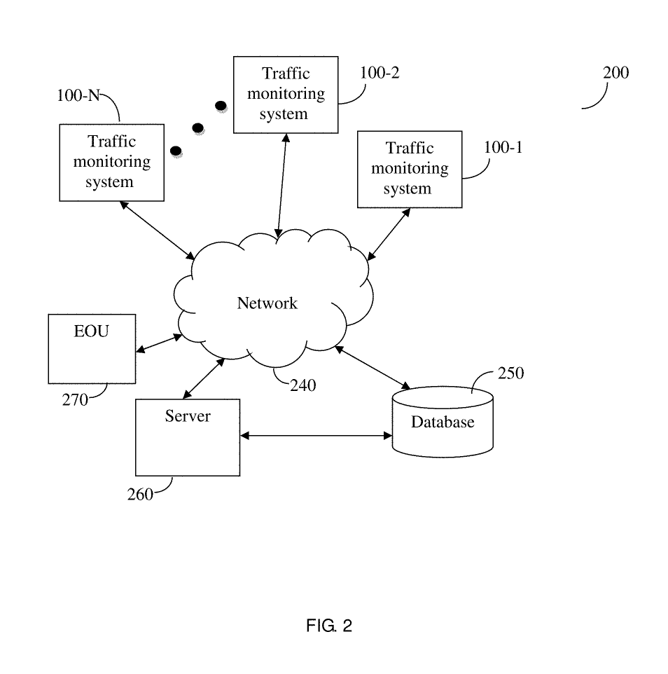

FIG. 2 is an example diagram 200 showing the deployment of multiple traffic monitoring systems 100-1 through 100-N (hereinafter referred to individually as a traffic monitoring system 100 and collectively as traffic monitoring systems 100, merely for simplicity purposes) according to an embodiment. Each traffic monitoring system 100 is positioned in a specific location. The location is determined based on the field of view required for detecting violations by the traffic monitoring system 100. Each traffic monitoring system 100 (e.g., the traffic monitoring system 100-1) may detect a potential violation based on data streams provided by the other traffic monitoring systems 100, e.g., the traffic monitoring systems 100-2 through 100-N.

A data stream may include a video clip captured by the camera (e.g., the camera 110, FIG. 1) and optionally metadata. The metadata may include a time and date in which the video stream was captured as well as any processing results (e.g., identified licensing plate, traffic patterns, and the like). Such metadata provided by a first monitoring system (e.g., the traffic monitoring system 100-1) may be utilized for processing by a second monitoring system (e.g., the traffic monitoring system 100-2).

In another embodiment, data streams from two or more of the traffic monitoring systems 100 are combined into a single event to allow identification of a traffic violation. Each event is a collection of data representing the monitoring of a particular vehicle during a predefined time interval (e.g., 30 seconds) and a specific location.

This embodiment allows for wider coverage of sources of data representing potential traffic violations, as each traffic monitoring system 100 can capture a different field of view. The data streams can be shared between the traffic monitoring systems upon demand or based on a predetermined configuration. For example, the traffic monitoring system 100-1 may be configured to send all its data streams to the traffic monitoring system 100-2.

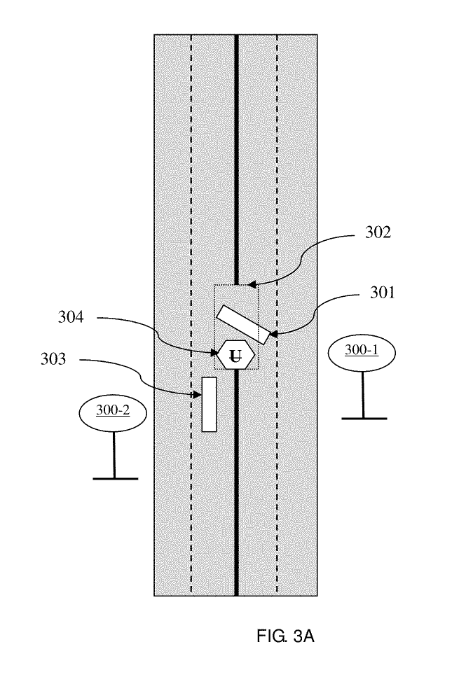

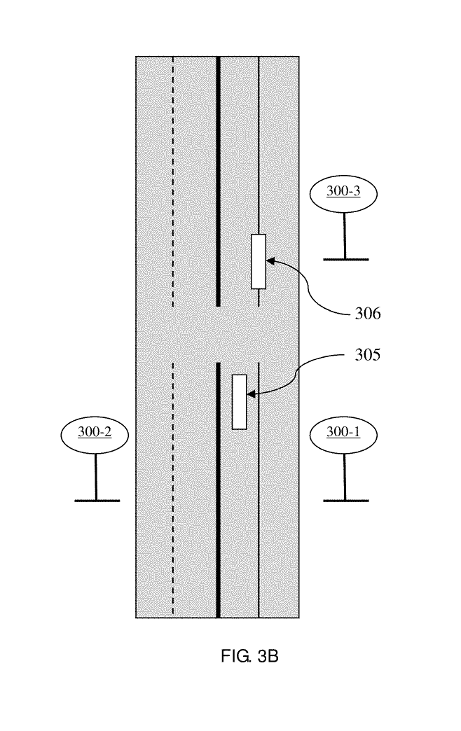

An example for detecting a violation using the traffic monitoring system 100-1 is illustrated in FIG. 3A. A monitoring traffic monitoring system 300-1 is geographically positioned across the road from a traffic monitoring system 300-2. If the traffic monitoring system 300-1 identifies a vehicle at location 301 turning left at a highway divider 302 and receives a data stream from the traffic monitoring system 300-2 identifying the same vehicle at location 303 subsequently driving on the opposite lane, then there is a violation of the “no U-turns” sign (304).

As another example, shown in FIG. 3B, a third traffic monitoring system 300-3 is positioned at a junction along the same road as the first traffic monitoring system 300-1. The traffic monitoring system 300-3 receives data streams from the traffic monitoring system 300-1 and, using its own captured video streams along with the video streams from the traffic monitoring system 300-1, the system 300-3 can determine whether a vehicle at location 305 is merging in or out of the lane at location 306 and, therefore, whether the vehicle is committing a violation.

Returning back to FIG. 2, according to the disclosed embodiments, the traffic monitoring systems 100-1 through 100-N communicate, through a network 240, with a database 250, a server 260, and an enforcement office unit (EOU) 270 to send and receive information at least about suspect violations, data streams, or both.

In an embodiment, each traffic monitoring system 100 may be configured to generate reports of suspect violations based on streams from any of the traffic monitoring systems 100. A reported suspect violation may include a video clip and may optionally one or more high resolution photos demonstrating the violation. Such a report may also include, but is not limited to, a time of day, date, location, type(s) of violation, and other information to be viewed by an enforcement officer via the EOU 270.

In another embodiment, the data streams may be received at the server 260. The server 260 is configured to process such data streams to validate suspect violations or identify violations that we were not captured by the traffic monitoring systems. Any violation identified or detected by the server 260 may be reported to the EOU 270, stored in the database 250, or both.

The network 240 may be wired or wireless, and may further be part of a local area network (LAN), a wireless LAN, a wide area network (WAN), a metro area network (MAN), a cellular network, the world wide web (WWW), the Internet, and the like. The network 240 can be utilized for on-line data transfer, off-line data transfer, or both.

An enforcement officer may use an EOU 270 to communicate through the network 240 with the server 260 and the database 250 for the purpose of retrieving suspect moving or non-moving violations. The enforcement officer may view, on the EOU 270, the video clip(s) related to the suspect violations to determine if a violation actually happened and, if so, determine from the high resolution still images the precise information about the violating vehicle.

Upon determination that a violation has occurred, a traffic citation (ticket) may be prepared accompanied with the necessary evidence which may be stored (e.g., in the database 250) for future use. In one embodiment, the citation may be automatically generated and sent to the vehicle's owner. The citation may be sent in an electronic form (e.g., an email), and may include a web link (e.g., a URL) to the video clip(s) and any high resolution photos so that the violator can view the evidence. In another embodiment, video clips may be recorded onto computer readable media (e.g., DVD) and mailed to the person receiving the citation.

In yet another embodiment, the EOU 270 is further configured to obtain, from the database 250, data related to past violations associated with the offending vehicle and to automatically recommend the enforcement officer to generate a response that accounts with the violator's history. For example, and without limitations, an enforcement officer may determine that in view of the offender's history and kind of violation that a warning should be generated rather than a ticket.

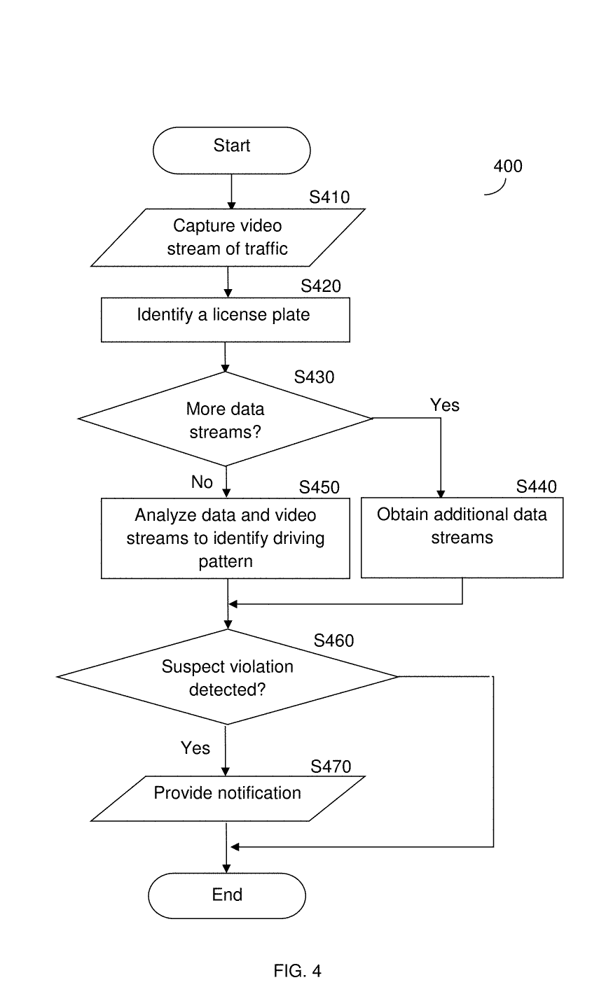

FIG. 4 depicts an example flowchart 400 illustrating a method for monitoring and enforcing traffic using multiple data streams according to an embodiment. In an embodiment, the method may be performed by a traffic monitoring system (e.g., the traffic monitoring system 100-1).

At S410, a video stream is continuously recorded to capture video of traffic in a location where a first traffic monitoring system (e.g., the traffic monitoring system 100-1) is positioned. The video stream may include high resolution photos, video clips, or a combination thereof captured by a camera installed in the first traffic monitoring system.

At S420, at least a license plate number of a vehicle in the traffic is identified in the video stream captured by the first traffic monitoring system. In an embodiment, S420 further includes determining other identifiers related to the vehicle. For example, such identifiers may include, but are not limited to, a color, make, and model of the vehicle. In another embodiment, the video frames in the captured video streams may be annotated. The annotations may include, for example, a pixel geometry of a license plate inside the video frame or high resolution picture, a textual representation of the license plate generated using an optical character recognition (OCR) system, and so on.

At S430, the captured video stream is analyzed to determine if a potential traffic violation can be identified solely based on the captured data stream. If so, execution continues with S440; otherwise, execution continues with S450. The determination at S430 is based on the field of view of the camera in the first traffic monitoring system. That is, the determination results in a “yes” answer only if the video stream captured by the camera allows a definitive decision that a violation has occurred, in which case no additional streams will be utilized.

At S440, one or more data streams from additional traffic monitoring systems positioned in geographic proximity to the first traffic monitoring system is requested or otherwise retrieved. That is, such data streams may be requested, on-demand, from other traffic monitoring systems. Alternatively, such data streams may be retrieved from a local storage of, for example, the first traffic monitoring system. A data stream may include a video clip captured by the camera and optionally metadata. The metadata may include a time and date in which the video stream was captured and any processing results (e.g., identified licensing plate, traffic patterns, and the like).

At S450, the video stream from the first monitoring system and the data streams retrieved from the other systems (if such are available) are analyzed to identify at least one driving pattern of the vehicle. Each driving pattern is identified for the vehicle for which the license plates have been identified at S420.

At S460, based on the identified at least one driving pattern and the license plates, it is determined if alleged suspect violation has occurred and, if so, execution continues with S470; otherwise, execution terminates.

In an embodiment, the determination at S460 is also based on the vehicle's location (e.g., a junction, a highway, a country road, a school zone, a street, and so on) and the traffic (or parking) restrictions in such locations.

In an embodiment, S460 includes comparing the identified driving pattern to a database providing illegal driving patterns. The illegal driving patterns are determined based on local traffic rules and the location of the vehicle. S460 may further include querying a database using the identified license plate to determine at least a classification of the vehicle and an eligibility of the vehicle to drive on the road. As a non-limiting example, the classification includes any one of a public transportation vehicle and a private vehicle. Some examples for S460 are discussed above.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What we claimed is:

1. A method for monitoring and enforcing suspect traffic violations, comprising:
capturing a video stream of traffic in a field of view of a first traffic monitoring system;
identifying a license plate number of a vehicle shown in the captured view stream;
obtaining data streams from at least one second traffic monitoring system;
identifying a driving pattern of the vehicle based on the captured video stream and the obtained data streams; and
analyzing the identified driving pattern and the license plate number of the vehicle to determine a suspect traffic violation committed by the vehicle.

2. The method of claim 1, further comprising:
upon determining the suspect traffic violation, generating a citation, wherein the citation includes at least one video clip evidencing the traffic violation.

3. The method of claim 2, further comprising:
sending the citation to at least one of: an owner of the vehicle, and an enforcement officer.

4. The method of claim 1, wherein each of the obtained data streams includes a video clip captured by the second traffic monitoring system and metadata generated by the second traffic monitoring system.

5. The method of claim 1, wherein analyzing the identified driving pattern and the license plate number further comprises:
comparing the identified driving pattern to data in a database indicating illegal driving patterns, wherein the illegal driving patterns are determined based on local traffic rules in a location of the first traffic monitoring system.

6. The method of claim 1, further comprising:
querying a database using the identified license plate number to determine at least a classification of the vehicle and an eligibility of the vehicle to drive on a road within the field of view of the first traffic monitoring system.

7. The method of claim 1, wherein the classification includes any one of: a public transportation vehicle, and a private vehicle.

8. The method of claim 1, wherein the traffic violation further includes a parking violation.

9. The method of claim 1, wherein each of the first traffic monitoring system and each of the at least one second traffic monitoring system is any one of: a stationary system, and a portable system.

10. The method of claim 1, wherein the first traffic monitoring system and each of the at least one the second traffic monitoring system are positioned in geographic proximity to each other.

11. A non-transitory computer readable medium having stored thereon instructions for causing a processing circuity to execute the method according to claim 1.

12. A system for monitoring and enforcing suspect traffic violations comprising, comprising:
at least one camera;
a processing circuity; and
a memory, the memory containing instructions that, when executed by the processing circuity, configure the system to:
capture, using the at least one camera, a video stream of traffic in a field of view of a first traffic monitoring system;
identify a license plate number of a vehicle shown in the captured view stream;
obtain data streams from at least one second traffic monitoring system;
identify a driving pattern of the vehicle based on the captured video stream and the obtained data streams; and
analyze the identified driving pattern and the license plate number of the vehicle to determine a suspect traffic violation committed by the vehicle.

13. The system of claim 12, wherein the system is further configured to:
upon determining the suspect traffic violation, generate a citation, wherein the citation includes at least one video clip evidencing the traffic violation.

14. The system of claim 12, wherein the system is further configured to:
send the citation to at least one of: an owner of the vehicle, and an enforcement officer.

15. The system of claim 12, wherein each of the obtained data streams includes a video clip captured by the second traffic monitoring system and metadata generated by the second traffic monitoring system.

16. The system of claim 12, wherein the system is further configured to:
compare the identified driving pattern to data in a database indicating illegal driving patterns, wherein the illegal driving patterns are determined based on local traffic rules in a location of the first traffic monitoring system.

17. The system of claim 12, wherein the system is further configured to:
query a database using the identified license plate number to determine at least a classification of the vehicle and an eligibility of the vehicle to drive on a road within the field of view of the first traffic monitoring system.

18. The system of claim 12, wherein the classification includes any one of: a public transportation vehicle, and a private vehicle.

19. The system of claim 12, wherein the traffic violation further includes a parking violation.

20. The system of claim 12, wherein each of the first traffic monitoring system and the second traffic monitoring system is any one of: a stationary system, and a portable system.

21. The method of claim 12, wherein the first traffic monitoring system and each of the at least one second traffic monitoring system are positioned in geographic proximity to each other.
